(19) United States
(12) Patent Application Publication
(10) Pub. No.: US 2026/0186176 A1
(43) Pub. Date: Jul. 2, 2026

(54) DISPLAY APPARATUS

(71) Applicant: LG Display Co., Ltd., Seoul (KR)

(72) Inventor: Gyeore Lee, Suncheon-si (KR)

(21) Appl. No.: 19/383,019

(22) Filed: Nov. 7, 2025

(30) Foreign Application Priority Data
Dec. 31, 2024 (KR) 10-2024-0201813

(51) Int. Cl. G02B 5/00

(52) U.S. Cl. CPC G02B 5/003; G02B 2207/123

(57) ABSTRACT

A display apparatus can allow an outer shape of each film can be accurately recognized to secure alignment accuracy during a manufacturing process of the display apparatus. In the display apparatus, a second adhesive layer, a light control film, and a first adhesive layer may be sequentially stacked upward from a display panel including an active area and a non-active area, an outer edge of the light control film may be positioned on an outermost edge, and outer edges of the first adhesive layer and the second adhesive layer may be positioned further inward than the outer edge of the light control film. The outer edge of the first adhesive layer may include a chamfered portion that is recessed inward at each of four corner areas of the display panel. Accordingly, the display apparatus can enable smoother critical to quality (CTQ) measurements by securing alignment accuracy of films.

### CROSS REFERENCE TO RELATED APPLICATION

Pursuant to 35 U.S.C. § 119(a), this application claims the benefit of an earlier filing date and right of priority to Korean Patent Application No. 10-2024-0201813, filed Dec. 31, 2024 in the Korean Intellectual Property Office, the contents of which are incorporated by reference herein in their entirety.

### TECHNICAL FIELD

The present disclosure generally relates to a display apparatus.

### BACKGROUND

In general, examples of a display apparatus include an organic light-emitting diode (OLED) display apparatus that emits light by itself, a liquid crystal display (LCD) apparatus that requires a separate light source, etc.

Recently, display apparatuses including a light-emitting diode (LED) have been attracting attention as next-generation display apparatuses. Each light-emitting diode can be disposed on an active area (AA) of a display panel.

### SUMMARY

According to an example implementation of the present disclosure, there is provided a display apparatus in which a second adhesive layer, a light control film, and a first adhesive layer may be sequentially stacked upward from a display panel including an active area and a non-active area, an outer edge of the light control film may be positioned on an outermost edge, and outer edges of the first adhesive layer and the second adhesive layer may be positioned further inward than the outer edge of the light control film. The outer edge of the first adhesive layer may include at least one chamfered portion that is recessed inward from each of four corner areas of the display panel.

Implementations of such features can provide a variety of technical effects. For example, according to the example implementations of the present specification, since the outer edges of the films disposed above and below the display panel are disposed so as not to overlap each other, it is possible to smoothly conduct critical to quality (CTQ) measurement during the manufacturing process.

In addition, according to the example implementations of the present specification, it is possible to secure the alignment accuracy of the films for CTQ measurement during the manufacturing process of the display apparatus.

In addition, according to the example implementations of the present specification, since the edges of the films stacked above and below the display panel are stacked to be offset inward from the outer edges, it is possible to prevent occurrence of the boundary visibility defect of each film.

In addition, according to the example implementations of the present specification, it is possible to conduct CTQ measurement without misrecognition of the shape of each film during the manufacturing process of the display apparatus, thereby eliminating process defects.

In addition, according to the example implementations of the present specification, since the display panel is manufactured without misrecognition of the shape of each film during the manufacturing process of the display apparatus, it is possible to eliminate defects in the display panel.

In addition, according to the example implementations of the present specification, it is possible to eliminate the defects of the display panel, thereby preventing a reduction in the lifetime of the panel.

In addition, according to the example implementations of the present specification, by preventing panel defects so that the display panel operates without any failure, it is possible to provide a long-life and low-power display apparatus.

Effects of the present specification are not limited to the above-described effects, and other effects that are not described will be able to be clearly understood by those skilled in the art based on the following description.

Specific effects of the present specification together with the above-described effects are described together with a description of the following detailed matters for carrying out the example implementations of the specification.

It is to be understood that both the foregoing general description and the following detailed description are example and explanatory and are intended to provide further explanation of the inventive concepts as claimed.

### BRIEF DESCRIPTION OF DRAWINGS

FIG. 1 is a schematic plan view showing an example of a display apparatus according to an implementation of the present specification.

FIG. 2 is a block diagram showing an example of the display apparatus according to the implementation of the present specification.

FIG. 3 is a schematic view showing an example of a circuit of a sub-pixel of the display apparatus according to the implementation of the present specification.

FIG. 4 is a cross-sectional view of an example of the display apparatus according to the implementation of the present specification along the A-A′ in FIG. 1.

FIG. 5 is a view showing an example of an arrangement shape of a light control film and a first adhesive layer according to the implementation of the present specification.

FIG. 6 is a view showing an example of measuring the light control film and the first adhesive layer according to the implementation of the present specification using a measuring camera.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTIONS

The present disclosure relates to a display apparatus, for example, without limitation, a display apparatus capable of securing alignment accuracy of films.

The display panel can be attached to a cover member to protect a plurality of light-emitting diodes. In addition to the cover member, various films can be disposed above and below the display panel.

As an example, a display apparatus can be manufactured in a rectangular shape similar to a shape of a display panel for each film. These films are used in a manufacturing process of the display apparatus by reflecting only a chamfered portion at one corner to distinguish front and rear surfaces.

After the films are attached above and below the display panel, an operator can measure a degree of attachment by performing a measurement, such as a critical to quality (CTQ) measurement, using a microscope.

However, since the rectangular films are overlapped and stacked, there can arise a problem that outer shapes of the films are not accurately recognized and thus alignment accuracy is not secured.

Accordingly, implementations of the present disclosure can provide a display apparatus that enables the outer shape of each film to be accurately recognized to secure alignment accuracy during the manufacturing process of the display apparatus.

Implementations of the present specification can provide a display apparatus in which films are stacked, so that an edge of each of the films above and below a display panel is offset inward from an outer edge by a predetermined distance. This can have a technical effect of preventing occurrence of poor boundary visibility of each film.

Objects of the present specification are not limited to the above-described objects, and other objects and advantages of the present specification which are not mentioned can be understood by the following description and more clearly understood by implementations of the present specification. In addition, it will be able to be easily seen that the objects and advantages of the present specification can be achieved by devices and combinations thereof that are described in the claims.

Reference will now be made in detail to implementations of the present disclosure, examples of which may be illustrated in the accompanying drawings. The progression of processing steps and/or operations described is an example; however, the sequence of steps and/or operations is not limited to that set forth herein and may be changed as is known in the art, with the exception of steps and/or operations necessarily occurring in a particular order. Names of the respective elements used in the following explanations may be selected only for convenience of writing the specification and may be thus different from those used in actual products.

The above-described objects, features, and advantages will be described below in detail with reference to the accompanying drawings, and thus those skilled in the art to which the present disclosure pertains will be able to easily carry out the technical spirit of the present disclosure. In describing the present disclosure, when it is determined that a detailed description of the known technology related to the present disclosure may unnecessarily obscure the gist of the present disclosure, a detailed description thereof will be omitted. Hereinafter, example implementations according to the present disclosure will be described in detail with reference to the accompanying drawings. In the drawings, the same reference numerals are used to denote the same or similar components. Further, the present disclosure is only defined by scopes of claims.

Since shapes (e.g., sizes, lengths, widths, heights, thicknesses, locations, radii, diameters, and areas), ratios, angles, numbers, and the like disclosed in the drawings for describing the implementations of the present disclosure are examples, the present disclosure is not limited to the illustrated items. The same reference number denotes the same components throughout the specification. In addition, in describing the present disclosure, when it is determined that the detailed description of a related known technology may unnecessarily obscure the gist of the present disclosure, detailed description thereof will be omitted. Any implementation described herein as an “example” is not necessarily to be construed as preferred or advantageous over other implementations.

An implementation, an example, an example implementation, an aspect, or the like may refer to one or more implementations, one or more examples, one or more example implementations, one or more aspects, or the like, unless stated otherwise. Further, the term “may” encompasses all the meanings of the term “can.”

When “comprises,” “has,” “consists of,” etc. described in the present specification are used, other parts may be added unless “only” is used. When a component is expressed in a singular form, it includes a case in which the component is provided as a plurality of components unless specifically stated otherwise.

In construing a component, the component is construed as including a margin of error even when there is no separate explicit description.

In addition, when a first component is described as being “connected,” “coupled,” or “joined” to a second component, the components may be directly connected or joined, but it should be understood that a third component may be “interposed” between the components, or the components may be “connected,” “coupled,” or “joined” through the third component.

When a positional relationship is described, for example, when the positional relationship between two parts is described using “on,” “above,” “under,” “next to,” etc., one or more other parts may be positioned between the two parts unless “immediately” or “directly” is used.

When a temporal relationship is described, for example, when the temporal relationship is described using “after,” “subsequently,” “then,” “before,” etc., it may include a non-consecutive case unless the term “immediately” or “directly” is used.

The terms, such as “below,” “lower,” “above,” “upper” and the like, may be used herein to describe a relationship between element(s) as illustrated in the drawings. It will be understood that the terms are spatially relative and based on the orientation depicted in the drawings.

Although terms such as first and second, “A,” “B,” “(a),” and “(b)” are used to describe various components, these components are not limited by these terms. The terms are only used to distinguish one component from another. Accordingly, a first component described below may be a second component within the technical spirit of the present disclosure.

The terms “X-axis direction,” “Y-axis direction,” and “Z-axis direction” should not be construed as merely the geometric relationship in which the relationship therebetween is perpendicular and may refer to a wider directionality within the range in which the configuration of the present specification may act functionally.

The term “at least one” should be understood to include all combinations that can be presented from one or more relevant items. For example, the meaning of “at least one of first, second, and third items” can mean not only each of the first, second, and third items, but also any combination of items that can be presented from two or more of the first, second, and third items.

Features of various implementations of the present disclosure may be partially or overall coupled to or combined with each other, and may be variously inter-operated with each other and driven technically as those skilled in the art can sufficiently understand. Implementations of the present disclosure may be carried out independently from each other, or may be carried out together in co-dependent relationship.

Unless otherwise defined, all terms (including technical and scientific terms) used in the specification may be used as meaning commonly understood by those skilled in the art to which the present disclosure pertains. In addition, terms defined in commonly used dictionaries are not construed ideally or excessively unless clearly and specially defined.

Hereinafter, a display apparatus according to an example implementation of the present specification will be described.

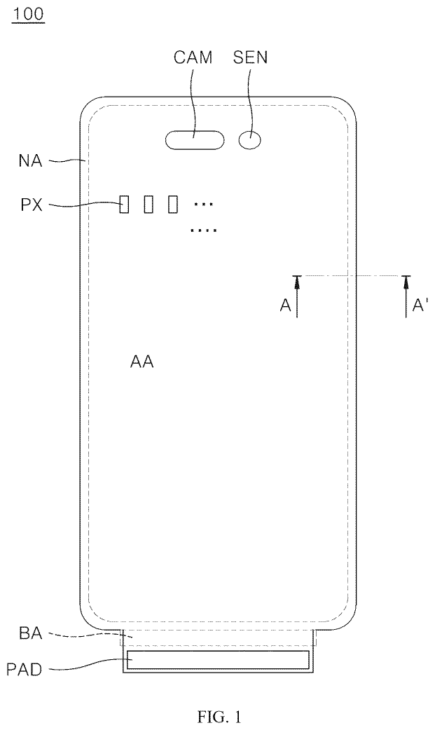

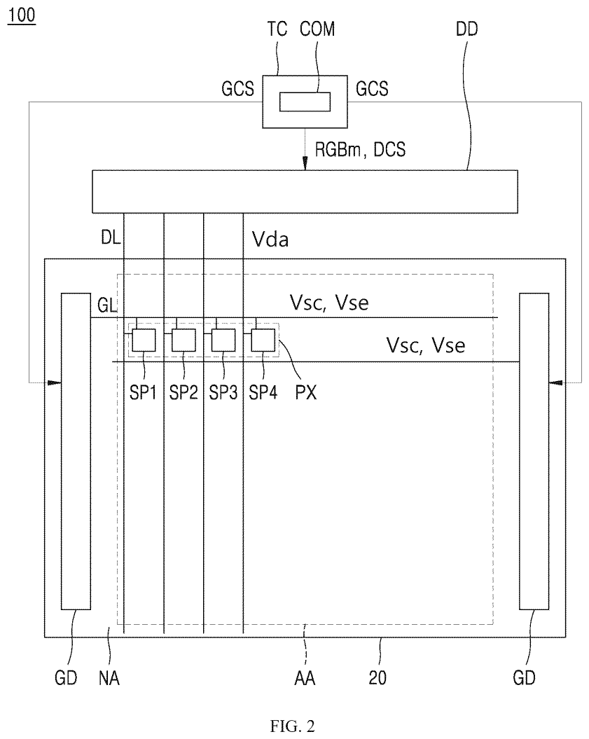

FIG. 1 is a schematic plan view showing an example of a display apparatus according to an implementation of the present specification. FIG. 2 is a block diagram showing an example of the display apparatus according to the implementation of the present specification.

Referring to FIG. 1, a display apparatus 100 according to an example implementation may include a display panel 20 for displaying an image. The display panel 20 may include a plurality of areas. For example, the display panel 20 may include one or more active areas AA on which an image is displayed, and a plurality of pixels PX may be disposed inside the active area AA. As an example, the display panel 20 may further include one or more folding areas FA, without being limited thereto. As an example, a folding area FA may be disposed between the plurality of active areas AA. As an example, a folding area FA may be disposed between the plurality of active areas AA in a vertical direction, without being limited thereto. As an example, a folding area FA may be disposed between the plurality of active areas AA in a direction other than the vertical direction, such as a lateral direction or a diagonal direction, without being limited thereto. As an example, the display panel 20 may further include a non-active area NA. As an example, the non-active area NA may extend from the active area AA or the folding area FA. As an example, the non-active area NA may fully or partially surround the plurality of active areas AA and the folding area FA, without being limited thereto. The non-active area NA on which no image is displayed may include a driving circuit unit and/or a dam unit and may be provided on one side surface of the active area AA. The driving circuit unit may be electrically connected to the plurality of pixels PX. In addition, as an example, the non-active area NA may include a printed circuit such as a flexible printed circuit board (PCB), a pad part PAD that may be electrically connected to driving circuits such as a chip-on-film (COF), and a bending part BA in which a substrate may be bent, without being limited thereto. Although not shown in the drawing, as an example, a touch insulating film may be disposed on the plurality of pixels PX and the driving circuit unit, without being limited thereto. As an example, the non-active area NA may be at least partially invisible from a front side of the display panel 20, for example, by being bent toward a rear side of the display panel 20, without being limited thereto.

Referring to FIG. 1, the non-active area NA may surround the substantially rectangular active area AA and may be positioned outside the active area AA. However, it should be understood that shapes of the active area AA and the arrangement of the non-active area NA adjacent to the active area AA are not specifically limited to the example display apparatus 100 shown in FIG. 1. The active area AA and the non-active area NA may have any shape of the display apparatus 100. Examples of these shapes may include a pentagon, hexagon, circle, oval, etc., and the example implementations of the present specification are not limited thereto.

Each pixel PX of the active area AA may include sub-pixels, and the sub-pixels may display colors of red (R), green (G), blue (B), white (W), etc. Implementations are not limited thereto. As an example, other subpixels displaying colors other than red, green, blue, white, such as cyan, magenta, or yellow, etc. may be alternatively or additionally included. In addition, each of the pixel PX and the sub-pixel may include a pixel circuit including one or more thin film transistors TFT manufactured on the substrate of the display apparatus 100. Each pixel circuit may be electrically connected to a gate line GL and a data line DL to communicate with one or more driving circuits, for example, a gate driver GD and a data driver DD positioned in the non-active area NA of the display apparatus 100. Implementations are not limited thereto. As an example, the gate driver GD and the data driver DD may be not positioned in the non-active area NA of the display apparatus 100, but may be disposed on a separate panel or film and connected to the display panel 20, for example, using a tape automated bonding (TAB) method, a chip-on-glass (COG) method, a chip-on-panel (COP) method, a chip-on-film (COF) method, without being limited thereto.

As an example, the active area AA may include a camera area CAM and a sensor area SEN, without being limited thereto.

As an example, a camera may be disposed below the substrate in the camera area CAM, and sensors such as a distance detection sensor or a face recognition sensor may be disposed in the sensor area SEM, without being limited thereto.

The display apparatus 100 may be an organic light-emitting diode (OLED) display apparatus, but the example implementations of the present specification are not limited thereto. For example, the display apparatus may be a quantum dot display apparatus, a micro LED display apparatus, or a mini LED display apparatus, without being limited thereto.

Referring to FIG. 2, the display apparatus 100 according to the example implementation of the present specification includes a timing controller TC, a compensator COM, a data driving unit DD, a gate driving unit GD, and the display panel 20, without being limited thereto.

The timing controller TC may generate image data, a data control signal DCS, and a gate control signal GCS using an image signal and a plurality of timing signals such as a data enable signal, a horizontal synchronization signal, a vertical synchronization signal, a clock, etc. transmitted from an external system such as a graphic card or a TV system.

The compensator COM may generate compensation image data RGBm that compensates for the image data using information such as time, temperature, etc., without being limited thereto.

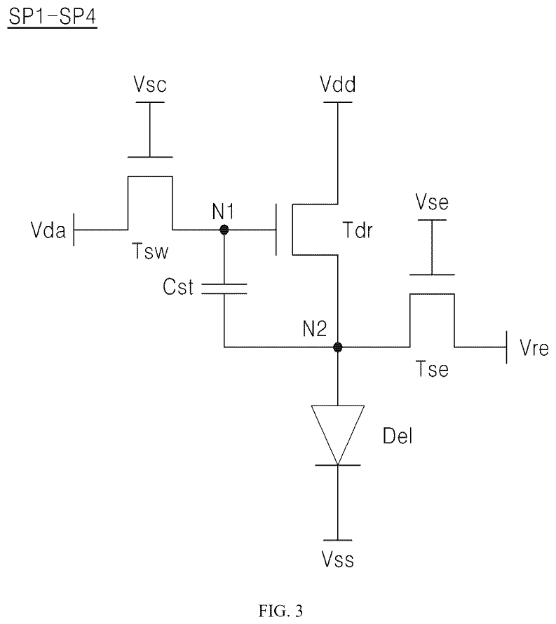

The data driving unit DD generates a data signal Vda (see FIG. 3) using the compensation image data RGBm and the data control signal DCS transmitted from the timing controller TC and applies the generated data signal to the data line DL of the display panel 20.

The gate driving unit GD generates gate signals Vsc and Vse (see FIG. 2) using the gate control signal GCS transmitted from the timing controller TC and applies the generated gate signals Vsc and Vse (see FIG. 2) to the gate line GL of the display panel 20.

Here, the gate driving unit GD may be a gate in panel (GIP) type formed together on the substrate of the display panel 20 on which the gate line GL, the data line DL, and the pixels PX are formed and disposed in the non-active area NA.

The display panel 20 includes a plurality of active areas AA, a folding area FA between the plurality of active areas AA, and a non-active area NA surrounding the plurality of active areas AA and the folding area FA and displays an image using the gate signals Vsc and Vse and the data signal Vda.

The display panel 20 may be used for one of a liquid crystal display (LCD) apparatus, a field emission display (FED) apparatus, an electroluminescence display (ELD) apparatus, and an organic light-emitting diode (OLED) display apparatus and may be used for the OLED display apparatus, which is a representative flexible display apparatus that can maintain display performance even when bent like paper. Since the OLED display apparatus is a self-luminous apparatus and does not require a backlight used for the LCD apparatus, which is a non-self-light-emitting apparatus, it can be made light and thin. Compared to the LCD apparatus, the OLED display apparatus can have an excellent viewing angle and contrast ratio, can be advantageous in terms of power consumption, driven by a low DC voltage, can have a fast response time, can be resistant to an external impact because its internal components are solid, and can have a wide operating temperature range. In particular, since a manufacturing process is simple, it is possible to reduce a production cost significantly compared to conventional LCD apparatuses.

The display panel 20 includes the plurality of pixels PX, the plurality of gate lines GL, and the plurality of data lines DL disposed in the active area AA to display an image.

As an example, each of the plurality of pixels PX includes first to fourth sub-pixels SP1 to SP4, the gate lines GL and the data lines DL intersect each other to define the first to fourth sub-pixels SP1 to SP4, and each of the first to fourth sub-pixels SP1 to SP4 is connected to the gate lines GL and the data lines DL. For example, the first to fourth sub-pixels SP1 to SP4 may correspond to red, green, blue, and white, but are not limited thereto. Although it is described and illustrated that each of the plurality of pixels PX includes four sub-pixels, implementations are not limited thereto. As an example, each of the plurality of pixels PX includes one or more sub-pixels. As an example, the one or more sub-pixels included in each of the plurality of pixels PX may be arranged in a line or in a array, without being limited thereto.

The first to fourth sub-pixels SP1 to SP4 may each include a plurality of transistors, such as a switching transistor Tsw (see FIG. 3), a driving transistor Tdr (see FIG. 3), and a sensing transistor Tse (see FIG. 3), a storage capacitor Cst (see FIG. 3), and a light-emitting diode Del (see FIG. 3), without being limited thereto. As an example, one or more of the above-mentioned components may be omitted, or one or more additional components such as a transistor or a capacitor may be further included.

FIG. 3 is a schematic view showing an example of a circuit of a sub-pixel of the display apparatus according to the example implementation of the present specification and will be described with reference to FIG. 2 together.

As shown in FIG. 3, each of the first to fourth sub-pixels SP1 to SP4 of the display apparatus 100 according to the example implementation of the present specification includes the switching transistor Tsw, the driving transistor Tdr, the sensing transistor Tse, the storage capacitor Cst, and the light-emitting diode Del.

In the example implementation of FIG. 3, an example in which each of the first to fourth sub-pixels SP1 to SP4 has a 3T1C structure including three transistors and one capacitor is described, but in other implementations, each of the first to fourth sub-pixels SP1 to SP4 may have one of a 6T1C structure including six transistors and one capacitor, a 7T1C structure including seven transistors and one capacitor, and an 8T1C structure including eight transistors and one capacitor, without being limited thereto.

In the example implementation of FIG. 3, an example in which all of the switching transistor Tsw, the driving transistor Tdr, and the sensing transistor Tse are of a negative (N) type is described, but in other implementations, at least one of the switching transistor Tsw, the driving transistor Tdr, and the sensing transistor Tse may be of a positive (P) type.

The switching transistor Tsw may be switched according to a scan signal Vsc to transmit the data signal Vda to a first node N1.

A gate electrode of the switching transistor Tsw may be connected to the gate line GL to receive the scan signal Vsc, a drain electrode of the switching transistor Tsw may be connected to the data line DL to receive the data signal Vda, and a source electrode of the switching transistor Tsw may be connected to the first node N1.

The driving transistor Tdr may be switched according to a voltage of the first node N1 to transmit a high-potential signal (a high-potential voltage) Vdd to a second node N2.

A gate electrode of the driving transistor Tdr may be connected to the first node N1, a drain electrode of the driving transistor Tdr may be connected to a high-potential power line to receive the high-potential signal Vdd, and a source electrode of the driving transistor Tdr may be connected to the second node N2.

The sensing transistor Tse may be switched according to the sensing signal (the sensing voltage) Vse to transmit a reference signal (a reference voltage) Vre to the second node N2 or transmit a voltage of the second node N2 to a reference line. As an example, the sensing transistor Tse may be omitted depending on the design.

A gate electrode of the sensing transistor Tse may be connected to the gate line GL to receive the sensing signal Vse, a drain electrode of the sensing transistor Tse may be connected to the reference line to receive the reference signal (the reference voltage) Vre or transmit the voltage of the second node N2 to the reference line, and a source electrode of the sensing transistor Tse may be connected to the second node N2.

The storage capacitor Cst may maintain the data signal Vda supplied to the first node N1 for a certain period (e.g., one frame) and store a threshold voltage Vth of the driving transistor Tdr.

First and second capacitor electrodes of the storage capacitor Cst may be connected to the first and second nodes N1 and N2, respectively.

The light-emitting diode Del may emit light having a brightness proportional to a current of the driving transistor Tdr.

A positive electrode of the light-emitting diode Del may be connected to the second node N2, and a negative electrode of the light-emitting diode Del may be connected to a low-potential power line to receive a low-potential signal (a low-potential voltage) Vss.

The source electrode of the switching transistor Tsw, the gate electrode of the driving transistor Tdr, and the first capacitor electrode of the storage capacitor Cst may form the first node N1, and the source electrode of the driving transistor Tdr, the source electrode of the sensing transistor Tse, the second capacitor electrode of the storage capacitor Cst, and the positive electrode of the light-emitting diode Del may form the second node N2.

In this way, the light-emitting diode Del may display an image having a brightness corresponding to image data according to the driving of the pixel circuit of the first to fourth sub-pixels SP1 to SP4.

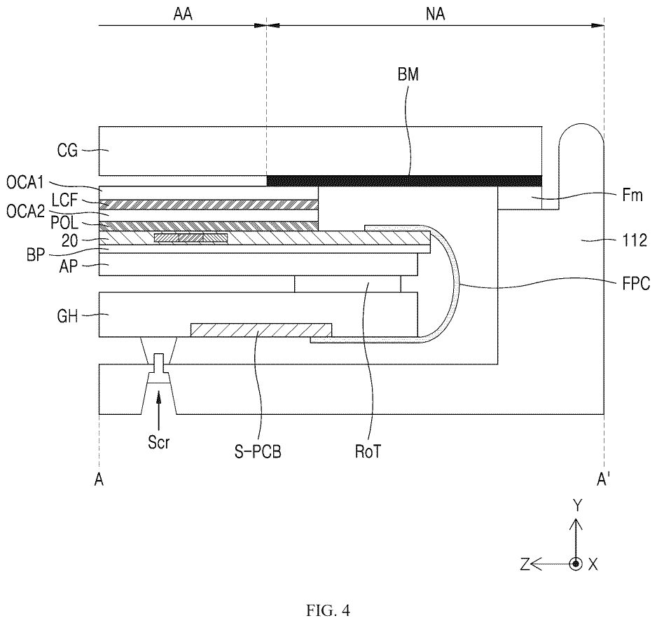

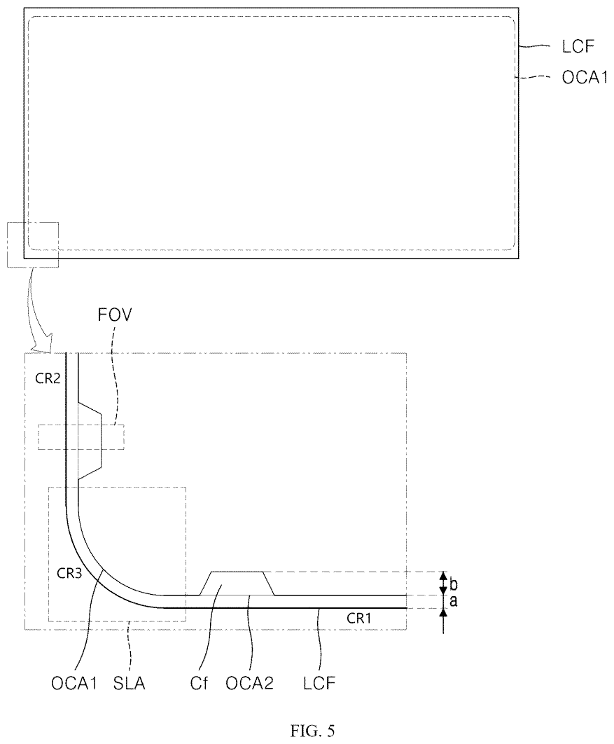

FIG. 4 is a cross-sectional view of an example of the display apparatus according to the example implementation of the present specification along the A-A′ in FIG. 1, and FIG. 5 is a view showing an example of an arrangement shape of a light control film and a first adhesive layer according to the example implementation of the present specification.

Referring to FIG. 4, the display apparatus 100 according to the example implementation of the present specification may include an optical control layer POL disposed on the display panel 20, a second adhesive layer OCA2 disposed on the optical control layer POL, a light control film LCF disposed on the second adhesive layer OCA2, a first adhesive layer OCA1 disposed on the light control film LCF, and a cover member CG disposed on the first adhesive layer OCA1. Implementations are not limited thereto. As an example, one or more of the above-mentioned components may be omitted depending on the design, or one or more additional components may be further included.

As an example, among the light control film LCF, the first adhesive layer OCA1, and the second adhesive layer OCA2, an outer edge of the light control film LCF may be positioned on the outside, and outer edges of the first adhesive layer OCA1 and the second adhesive layer OCA2 may be positioned more inward than the outer edge of the light control film LCF, without being limited thereto. Details of this structure will be described with reference to FIG. 5.

The outer edge of the first adhesive layer OCA1 may include a chamfered portion Cf (also referred to as chamfered shape Cf) that is recessed inward from each of four corner areas of the display panel 20. Here, the chamfered portion (or chamfered shape) Cf may be referred to as an angled C-cut shape, and thus may be referred to as a C-cut shape.

The light control film LCF is an optical film configured to control directionality of transmitted light and also referred to as a light collimating film. As an example, the light control film LCF includes a light transmissive film having a plurality of parallel grooves, and the grooves are filled with a light-absorbing material, without being limited thereto. Depending on the orientation, pitch, and geometry of the groove (e.g., an angle of a sidewall), the light control film LCF may provide increased or maximum transmission at a predetermined angle of incidence with respect to an image surface and provide image blocking or black-out along given polar coordinates (e.g., horizontally in the case of a so-called privacy filter or vertically when such a light control film is integrated into a vehicle instrument panel display).

The light control film LCF may be positioned adjacent to a display surface, an image surface, or other surface, which will be viewed. Typically, the light control film LCF is designed so that an image is visible at orthogonal incidence (i.e., a viewing angle of 0 degrees when a viewer views the image through the LCF in a direction perpendicular to its own film surface and the image surface). As the viewing angle increases, the amount of light transmitted through the LCF decreases until the viewing angle reaches a view blocking angle at which all light is virtually blocked by a light-absorbing material and the image is no longer visible. When the light control film LCF is used as a so-called privacy filter (e.g., for LCD apparatuses in computer monitors or laptop displays), this characteristic of the LCF may provide privacy to a viewer by blocking observation by others outside a typical viewing angle range.

The light control film LCF may be formed, for example, by molding a polymerizable resin on a polycarbonate substrate and ultraviolet-curing the polymerizable resin.

The light control film LCF may have both a “black out” function of a louver film and a “color conversion” function of a multilayer optical film (MOF).

The light control film LCF may include a first light absorber that absorbs light in a specific wavelength range. The light control film LCF including the first light absorber may selectively absorb light in the specific wavelength range, for example, a green wavelength range (e.g., 540 nm to 560 nm), without being limited thereto. Since the light control film LCF includes the first light absorber that absorbs light in the specific wavelength range that is, for example, most sensitive to the human eye, an organic light-emitting diode can lower a light reflectance that is most sensitive to the human eye even without using the optical control layer POL.

The first light absorber may be, for example, at least one selected from the group consisting of a quinone-based dye, an indigo-based dye, a quinacridone-based pigment, a polyene-based pigment, and an aromatic hydrocarbon dye/pigment, without being limited thereto.

For example, the quinone-based dye may be an anthraquinone-based pigment. The anthraquinone-based dye may have a simple substituent of anthraquinone, an acylaminoanthraquinone type, anthraquinonylamine or carbazole type, and a condensed ring of anthraquinone and a heterocycle, such as anthraquinone acridone or indanthrone flavanthrone and its derivatives, as its structural surface, without being limited thereto. The indigo-based dye is a natural dye that has been used as a vat dye for the longest time.

The light control film LCF may further include a second light absorber that absorbs light in the entire band, particularly, at least in a visible light range. Since the light control film LCF includes the second light absorber, the light control film LCF may absorb light in the entire band, particularly, at least in the visible light range. In addition, since the light control film LCF includes the first light absorber that further absorbs light in the specific wavelength range, the light control film LCF may further absorb light in the specific wavelength range while absorbing light in the entire band, particularly, at least in the visible light range. The second light absorber that absorbs light in the visible light range may be formed of at least one selected from the group consisting of carbon black, black pigment, and black dye, but is not limited thereto. The second light absorber may include, for example, a quinone-based dye, an indigo-based dye, a quinacridone-based pigment, a polyene-based pigment or dye, or an aromatic hydrocarbon-based pigment or dye.

The optical control layer POL may include, for example, a polarizing layer POL. The polarizing layer POL reduce or prevents a contrast ratio (CR) from being decreased by external light. In the display apparatus 100 according to the present specification, an OLED panel improves a contrast ratio by positioning a polarizing layer that blocks external light incident from the outside in a transmissive direction of light emitted through the display panel 20 when the OLED panel is in a driving mode that implements an image. As an example, the polarizing layer may be adhered to the cover member CG through an adhesive layer, without being limited thereto. The adhesive layer may be formed of at least one layer with at least one of an optical clear adhesive (OCA), an optical clear resin (OCR), or a pressure sensitive adhesive (PSA), without being limited thereto. The adhesive layer may have a thickness of, for example, 100 to 300 μm, without being limited thereto. When the adhesive layer has a thickness of 100 μm or less, adhesive strength is weak, making it difficult to modularize the cover member CG and a back plate BP, and when the adhesive layer has a thickness of 300 μm or more, the display apparatus 100 cannot be easily bent.

The cover member CG protects the display panel 20 from an external impact and transmits light emitted from the display panel 20 so that the image displayed on the display panel 20 may be viewed from the outside. The cover member CG may be referred to as cover glass or a cover window.

The cover member CG may be formed of one of polymethylmethacrylate (PMMA), polycarbonate (PC), cycloolefin polymer (COP), polyethylene terephthalate (PET), polyimide (PI), and polyaramid (PA), which have impact resistance and light transmittance. The example implementations of the present specification are not limited thereto.

The display panel 20 may include a plurality of pixels. Each of the plurality of pixels may be composed of a plurality of sub-pixels. One or a plurality of light-emitting elements may be disposed in each of the plurality of sub-pixels. The plurality of light-emitting elements may be configured differently according to the type of the display apparatus 100. For example, when the display apparatus 100 is an inorganic light-emitting display apparatus, the light-emitting element may be a light-emitting diode (LED), a micro LED, or a mini LED, but the example implementations of the present specification are not limited thereto.

A plurality of pixel driving circuits may be disposed on the display panel 20. The plurality of pixel driving circuits may be circuits for driving light-emitting elements of the plurality of sub-pixels. For example, each of the plurality of pixel driving circuits may serve as a driving transistor and a storage capacitor. For example, each of the plurality of pixel driving circuits may supply control signals, power, and driving current to the light-emitting elements of the plurality of sub-pixels to control the light-emitting operations of the plurality of light-emitting elements. For example, the pixel driving circuit may include a power line and a signal line for controlling light-emitting on/off and/or light-emitting time of the light-emitting element. For example, the plurality of pixel driving circuits may be driving drivers manufactured using a process of manufacturing a metal-oxide-silicon field effect transistor (MOSFET) on a semiconductor substrate, but the example implementations of the present specification are not limited thereto. The driving driver may drive the plurality of sub-pixels. For example, the plurality of pixel driving circuits may include a micro driver (μDriver), but the example implementations of the present specification are not limited thereto. The micro driver may be implemented in a form of a chip. For example, the plurality of pixel driving circuits may include a driver chip, but the example implementations of the present specification are not limited thereto.

The support member (the back plate) BP may be disposed below the display panel 20, and a metal plate(an aluminum plate) AP may be disposed below the back plate BP, without being limited thereto. As an example, the metal plate AP may be made of a material other than aluminum or a material other than metal, without being limited thereto. As an example, at least one of the support member (the back plate) BP and the metal plate(an aluminum plate) AP may be omitted depending on the design.

The metal plate AP and the support member BP may be attached to a rear surface of the display panel 20 to support the display panel 20 in case that the substrate of the display panel 20 is too thin.

As an example, the support member BP may include a material that may be manufactured by an etching process, without being limited thereto. For example, the support member BP may be formed of one of a metal material, a polymer material, a glass material, a carbon fiber reinforced plastic material, a carbon plate material, and an elastomer material, without being limited thereto. The metal material may be formed of, for example, iron (Fe), stainless steel containing metal, an aluminum (Al)-based material, or magnesium (Mg), without being limited thereto.

As an example, the support member BP may be formed of a metal material such as stainless steel (SUS), but is not limited thereto, and may be formed of a polymer material such as polymethylmetacrylate (PMMA), polycarbonate (PC), polyvinylalcohol (PVA), acrylonitrile-butadiene-styrene (ABS), polyethylene terephthalate (PET), silicon, or polyurethane (PU), without being limited thereto.

The display apparatus may include the metal plate AP disposed below the support member BP, an adhesive tape (resin or tape) RoT disposed below the metal plate AP, a guide holder GH disposed below the adhesive tape RoT, and a set frame 112 disposed below the guide holder GH. The guide holder GH may be fixedly joined to the set frame 112 for example, by a screw Scr, without being limited thereto.

The support member BP and the metal plate AP may support the display panel 20. The support member BP and the metal plate AP may be adhered by a resin or an adhesive tape, without being limited thereto. For example, the support member BP and the metal plate AP may be adhered using an ultraviolet (UV) curable acrylic resin, but are not limited thereto. Specifically, the resin disposed between the support member BP and the metal plate AP may be formed as a cured product of the resin subjected to a curing process. When the ultraviolet curing resin is used as the resin, ultraviolet curing may be performed.

The metal plate AP may be formed of a metal material, for example, an aluminum material, without being limited thereto.

In addition, the metal plate AP may be formed of a metal material, such as stainless steel (SUS), or a polymer material, such as polymethylmetacrylate (PMMA), polycarbonate (PC), polyvinylalcohol (PVA), acrylonitrile-butadiene-styrene (ABS), polyethylene terephthalate (PET), silicon, or polyurethane (PU), without being limited thereto.

In the example implementations of the present specification, although not shown in the drawings, a shock absorbing layer may be disposed below the support member BP. The shock absorbing layer can reduce or minimize an external shock from being transferred to the display panel 20. The shock absorbing layer may be formed of silicon, silicon foam, acrylic foam, polypropylene foam, polyurethane (PU), polyurethane foam, or thermoplastic polyurethane (TPU), but is not limited thereto.

The shock absorbing layer may have a thickness of 100 μm to 1000 μm, without being limited thereto. This is because, when the shock absorbing layer has a thickness of less than 100 μm, the shock absorbing capacity is insignificant, and when the shock absorbing layer has a thickness exceeding 1000 μm, the display apparatus cannot be easily folded. Implementations are not limited thereto. As an example, the shock absorbing layer may be omitted depending on the design.

The guide holder GH includes a source PCB therein, and the source PCB may be electrically connected to the display panel 20 through a flexible PCB FPC, without being limited thereto. As an example, the guide holder GH may be omitted depending on the design.

In addition, the display apparatus may have a black matrix BM disposed on the first adhesive layer OCA1, and the cover member CG is disposed on the black matrix BM.

As an example, the black matrix BM may include a plurality of holes and may be formed by being filled with a black pigment through the plurality of holes, without being limited thereto. As an example, the black matrix BM may be omitted depending on the design.

The black matrix BM may be disposed upward from the display panel 20 in the non-active area NA between the set frame 112 positioned at the outermost edge of the non-active area NA and the active area AA. For example, the black matrix BM may be disposed between the first adhesive layer OCA1 and the cover member CG upward from the display panel 20. As an example, one end of the black matrix BM may overlap a boundary between the active area AA and the non-active area NA, and the other end of the black matrix BM may overlap an end of the cover member CG, without being limited thereto. As an example, the black matrix BM may overlap a part of the light control film LCF, a part of the optical control layer POL, or a part of the display panel 20, without being limited thereto. As an example, the black matrix BM may extend beyond the display panel 20. As an example, the black matrix BM may extend onto the set frame 112 to overlap at least a part of the set frame 112, without being limited thereto.

The set frame 112 may have a flat bottom in the active area AA and the non-active area NA and extend upward from an end of the non-active area NA, and an end of the set frame 112 extending upward may be spaced a predetermined distance from an outer edge of the cover member CG, without being limited thereto.

The set frame 112 may have a stepped portion for seating the outer edge of the cover member CG. Accordingly, a foam member Fm coupled to the outer edge of the cover member CG may be seated on the stepped portion of the set frame 112. The foam member Fm may be formed in a form including a foam tape or a foam pad and may include a tape having a shock absorption function or a double-sided tape having conductivity. For example, the double-sided tape may include a conductive layer between an upper adhesive layer and a lower adhesive layer, and the adhesive layer may also include a conductive material. Implementations are not limited thereto. As an example, the foam member Fm may include a double-sided tape having no conductivity, without being limited thereto.

FIG. 5 shows an example where the outer edge of the first adhesive layer OCA1 and the outer edge of the second adhesive layer OCA2 may overlap each other except for the chamfered shapes Cf.

For example, the outer edges of the first adhesive layer OCA1 and the second adhesive layer OCA2 may be disposed to be spaced a first distance “a” inward from the outer edge of the light control film LCF, as shown in FIG. 5. In this case, the first distance a may be, for example, 0.25 millimeters (mm) or less, without being limited thereto.

Furthermore, as shown in the example of FIG. 5, the chamfered shape Cf formed on the outer edge of the first adhesive layer OCA1 may be formed to be further spaced a second distance “b” inward from the outer edge of the second adhesive layer OCA2, without being limited thereto. For example, the chamfered shape Cf formed on the outer edge of the first adhesive layer OCA1 may have a shape that is recessed in a trapezoidal shape inward from the outer edge of the second adhesive layer OCA2, without being limited thereto. In this case, the second distance b may be, for example, 0.50 millimeters (mm) or less, without being limited thereto. As an example, the chamfered shape Cf formed on the outer edge of the first adhesive layer OCA1 may have a shape that is recessed in a square shape, a rectangular shape, a circular shape, an oval shape, a rounded shape, a polygonal shape, etc. inward from the outer edge of the second adhesive layer OCA2, without being limited thereto.

The chamfered shape Cf formed on the outer edge of the first adhesive layer OCA1 may be formed as a plurality of chamfered shapes at one or more or each of the four corner areas of the display panel 20.

As shown in FIG. 5, in some implementations, the chamfered shape Cf formed on the outer edge of the first adhesive layer OCA1 may be formed as a plurality of chamfered shapes Cf at each of the four corner areas of the display panel 20 outside a spline area SLA of the display panel 20, without being limited thereto. As an example, the plurality of chamfered shapes Cf may be formed at both sides of the spline area SLA of the display panel 20, without being limited thereto. As an example, at least two chamfered shapes Cf may be disposed at each of four sides of the first adhesive layer OCA1, without being limited thereto.

The display panel 20 may have four spline areas SLA corresponding one-to-one to four corners having an arc shape.

Accordingly, the first adhesive layer OCA1 disposed upward from the display panel 20 may have four spline areas SLA corresponding one-to-one to four corners like the display panel 20.

Accordingly, the first adhesive layer OCA1 may have a chamfered shape Cf formed on each of outer edges of four sides outside the spline areas SLA of the four sides near the corner areas.

The display apparatus 100 according to the example implementation of the present specification may have spline areas SLA positioned at four corners of the second adhesive layer OCA2, the light control film LCF, and the first adhesive layer OCA1 corresponding to the display panel 20 having the spline areas at the four corners.

The second adhesive layer OCA2, the light control film LCF, and the first adhesive layer OCA1 may have a first spline area positioned at an upper left corner at which a horizontal side meets a vertical side, and a second spline area positioned at an upper right corner at which a horizontal side meets a vertical side.

In addition, the second adhesive layer OCA2, the light control film LCF, and the first adhesive layer OCA1 may have a third spline area positioned at a lower right corner at which a vertical side meets a horizontal side, and a fourth spline area positioned at a lower left corner at which a vertical side meets a horizontal side.

The light control film LCF disposed on the second adhesive layer OCA2, and the first adhesive layer OCA1 disposed on the light control film LCF may have a chamfered shape Cf formed on each of a left vertical side and an upper horizontal side adjacent to the first spline area outside the first spline area.

In addition, the first adhesive layer OCA1 may have a chamfered shape Cf formed on each of an upper horizontal side and a right vertical side adjacent to the second spline area outside the second spline area.

In addition, the first adhesive layer OCA1 may have a chamfered shape Cf formed on the right vertical side and a lower horizontal side adjacent to the third spline area outside the third spline area.

In addition, the first adhesive layer OCA1 may have a chamfered shape Cf formed on the lower horizontal side and a left vertical side adjacent to the fourth spline area outside the fourth spline area.

Meanwhile, the support member BP that supports the display panel 20 may be disposed below the display panel 20.

When the support member BP is attached to the display panel 20, pressure for attachment is applied, and the horizontal side, the vertical side, and the spline area are bent in a direction in which they are attached to the display panel 20.

The support member BP may be subjected to tensile stress due to a tensile force (Tensile) in the active area and subjected to compressive stress due to a compressive force (Compressive) in the non-active area.

The horizontal side may have a first curvature CR1 with which the support member BP is bent in a direction in which it is attached to the display panel 20, and the vertical side may have a second curvature CR2 with which the support member BP is bent in the direction in which it is attached to the display panel 20.

When the horizontal side and vertical side of the support member BP have the same degree of bending, the first curvature CR1 and the second curvature CR2 may have the same value.

However, the support member BP may have different values for the first curvature CR1 and the second curvature CR2 when the horizontal side and the vertical side are bent differently.

Each spline area SLA may be a composite curvature area in which horizontal bending meets vertical bending when the horizontal side and vertical side of the support member BP are bent.

Accordingly, each spline area may have a third curvature CR3 of the composite curvature by the horizontal side having the first curvature CR1 meeting the vertical side having the second curvature CR2.

In the support member BP, the first spline area positioned at an upper left end in which the horizontal side meets the vertical side may have a 3-1 curvature in which the horizontal side of the first curvature CR1 and the vertical side of the second curvature CR2 meet and are bent toward an upper left corner.

In the support member BP, the second spline area positioned at an upper right end in which the horizontal side meets the vertical side may have a 3-2 curvature in which the horizontal side of the first curvature CR1 and the vertical side of the second curvature CR2 meet and are bent toward an upper right corner.

In the support member BP, the third spline area positioned at a lower right end in which the horizontal side meets the vertical side may have a 3 -3 curvature in which the vertical side of the second curvature CR2 and the horizontal side of the first curvature CR1 meet and are bent toward a lower right corner.

In the support member BP, the fourth spline area positioned at a lower left end in which the horizontal side meets the vertical side may have a 3-4 curvature in which the vertical side of the second curvature CR2 and the horizontal side of the first curvature CR1 meet and are bent toward a lower left corner.

The 3-1 curvature, the 3-2 curvature, the 3-3 curvature, and the 3-4 curvature may have the same value.

The 3-1 curvature, the 3-2 curvature, the 3-3 curvature, and the 3-4 curvature may have different values.

The 3-1 curvature, the 3-2 curvature, the 3-3 curvature, and the 3-4 curvature may have sequentially decreasing values.

The 3-1 curvature, the 3-2 curvature, the 3-3 curvature, and the 3-4 curvature may have sequentially increasing values.

The 3-1 curvature may have a greater value than the 3-2 curvature, the 3-3 curvature, and the 3-4 curvature. The 3-1 curvature may have a smaller value than the 3-2 curvature, the 3-3 curvature, and the 3-4 curvature. Accordingly, the 3-2 curvature, the 3-3 curvature, and the 3-4 curvature may have the same value.

The 3-2 curvature may have a different value from the 3-1 curvature, the 3-3 curvature, and the 3-4 curvature. Accordingly, the 3-1 curvature, the 3-3 curvature, and the 3-4 curvature may have the same value. The 3-2 curvature may have a greater value than the 3-1 curvature, the 3-3 curvature, and the 3-4 curvature. The 3-2 curvature may have a smaller value than the 3-1 curvature, the 3-3 curvature, and the 3-4 curvature.

The 3 -3 curvature may have a different value from the 3-1 curvature, the 3-2 curvature, and the 3-4 curvature. Accordingly, the 3-1 curvature, the 3-2 curvature, and the 3-4 curvature may have the same value. The 3-3 curvature may have a greater value than the 3-1 curvature, the 3-2 curvature, and the 3-4 curvature. The 3-3 curvature may have a smaller value than the 3-1 curvature, the 3-2 curvature, and the 3-4 curvature.

The 3-4 curvature may have a different value from the 3-1 curvature, the 3-2 curvature, and the 3-3 curvature. Accordingly, the 3-1 curvature, the 3-2 curvature, and the 3-3 curvature may have the same value. The 3-4 curvature may have a greater value than the 3-1 curvature, the 3-2 curvature, and the 3-3 curvature. The 3-4 curvature may have a smaller value than the 3-1 curvature, the 3-2 curvature, and the 3-3 curvature.

The display apparatus 100 according to the example implementation of the present specification may have various curvatures that are not limited thereto. The display apparatus 100 according to the example implementation of the present specification may have various curvatures, for example, depending on differences in length or shapes of irregular portions.

Since the first adhesive layer OCA1 according to the example implementation of the present specification is adhered to the support member BP, the first adhesive layer OCA1 may be affected by each spline area SLA having the third curvature CR3 of the composite curvature formed by the horizontal side having the first curvature CR1 meeting the vertical side having the second curvature CR2.

Accordingly, the first adhesive layer OCA1 according to the example implementation of the present specification has a chamfered shape Cf on the outer edge of each of the four sides outside each spline area SLA so as not to or less to be affected by the third curvature CR3 acting in each spline area SLA.

The display apparatus 100 according to the example implementation of the present specification enables accurate CTQ measurement because the outer edges and chamfered shapes Cf of the four sides of each of the second adhesive layer OCA2, the light control film LCF, and the first adhesive layer OCA1 that correspond to a CTQ measurement portion are not affected by the curvature of each spline area SLA and thus the left-right and top-bottom alignment is maintained. Accordingly, since the CTQ measurement portion is clearly distinguished and recognized, accurate CTQ measurement can be conducted.

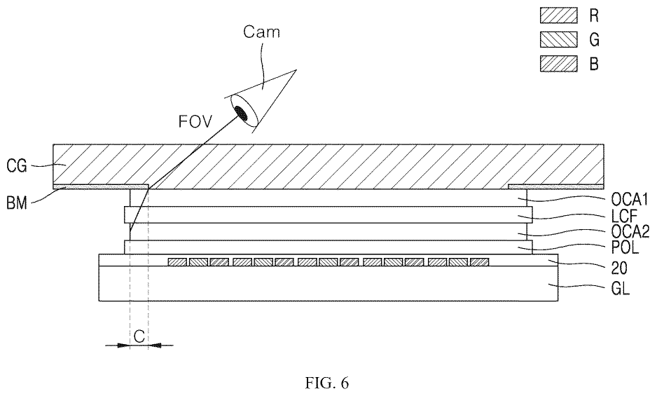

FIG. 6 is a view showing an example of measuring the light control film and the first adhesive layer according to the implementation of the present specification using a measuring camera.

Referring to FIG. 6, the display apparatus according to the example implementation of the present specification may have the black matrix BM disposed on the first adhesive layer OCA1, and the cover member CG disposed on the black matrix BM.

The black matrix BM may include a plurality of holes and may be formed by being filled with a black pigment through the plurality of holes, without being limited thereto.

The black matrix BM may include a black pigment (a black ink or a black resin), the concentration of the black pigment may be formed in a gradation form through a separate manufacturing process, and the black matrix BM may be disposed between the first adhesive layer OCA1 and the cover member CG. However, the black matrix BM is not limited thereto. For example, the black matrix BM may be formed in a gradation printing form on the cover member CG during the manufacturing process of the display panel 20. The gradation form of the black matrix BM may be a form in which the concentration of the black pigment is gradually darker from the active area AA toward the set frame 112. The black matrix BM may block light from being emitted from the plurality of sub-pixels to the non-active area NA.

A density of the black pigment in the black matrix BM may be higher from the active area AA toward the set frame 112 in the non-active area NA. As an example, the black matrix BM may have a lower density of the black pigment in the active area AA and a higher density of the black pigment on the set frame 112. Implementations are not limited thereto. As an example, the density of the black pigment in the black matrix BM may be uniform from the active area AA toward the set frame 112 in the non-active area NA, without being limited thereto. As an example, the black matrix BM may be omitted depending on the design.

The display apparatus 100 according to the example implementation of the present specification may be disposed such that the outer edge of each of the second adhesive layer OCA2, the light control film LCF, and the first adhesive layer OCA1 overlaps an end of the black matrix BM by a third distance C.

Accordingly, the chamfered shape formed on the outer edge outside the spline area of each of the four-sides of the first adhesive layer OCA1 may also be disposed at a position overlapping the end of the black matrix BM.

In addition, the chamfered shapes formed on the outer edges of the four sides outside the spline areas of the first adhesive layer OCA1, and the outer edges of the four sides of the second adhesive layer OCA2 and the outer edges of the four sides of the light control film LCF, which correspond to the chamfered shapes may each be positioned below the end of the black matrix BM and may overlap the end of the black matrix BM.

Accordingly, the outer edges of the second adhesive layer OCA2, the light control film LCF, and the first adhesive layer OCA1 are invisible from the outside (a viewer) by the black matrix BM, and the chamfered shapes formed on the four sides of the first adhesive layer OCA1 are also invisible from the outside (the viewer).

The CTQ measurement is conducted on the display apparatus according to the example implementation of the present specification by directing a measurement camera Cam to the end of the black matrix BM overlapping the outer edge of the first adhesive layer OCA1 adhered on the light control film LCF.

At this time, by positioning the focus of the measurement camera Cam at the third distance C from the outer edge of the first adhesive layer OCA1 or the outer edge of the light control film LCF, a focus of view FOV of the measurement camera Cam may be formed. As an example, the focus of view FOV of the measurement camera Cam may be smaller than or equal to the third distance C.

Here, the third distance C corresponding to the focus of view FOV may range from the outer edge of the light control film LCF positioned on the outermost edge to the innermost portion of the chamfered shape of the first adhesive layer OCA1 positioned on the innermost edge.

In addition, the third distance C which corresponds to the focus of view FOV may include the outer edges of the four sides of each of the first adhesive layer OCA1, the second adhesive layer OCA2, and the light control film LCF, and the chamfered shapes formed on the outer edges of the four sides of the first adhesive layer OCA1.

As an example, the third distance C may include the chamfered shapes formed on the outer edges of the four sides outside each spline area of the first adhesive layer OCA1, and the outer edges of the four sides of each of the second adhesive layer OCA2 and the light control film LCF, which correspond one-to-one to the chamfered shapes.

In addition, the third distance C may be the total distance in which an interior including the outer edges of each of the second adhesive layer OCA2 and the light control film LCF and the chamfered shapes of the first adhesive layer OCA1 is invisible from the outside when the focus of view is considered. Here, the first adhesive layer OCA1, the second adhesive layer OCA2, and the light control film LCF are used in the manufacturing of the display apparatus 100 and thus may be referred to as “materials.”

In the example implementation of the present specification, when the chamfered shape is designed to be within the total distance, the shapes (shapes of edges, chamfered shapes, etc.) of the materials may be invisible from the outside.

In addition, the third distance C may include a viewing area of the measurement camera Cam. The viewing area may be a position spaced, for example, 1.4 millimeters (mm) ±0.3 millimeters (mm) inward from the outer edge of the light control film LCF positioned at the outermost edge. Accordingly, as an example, the chamfered shape may be formed at a position spaced, for example, at least 1.1 millimeters (mm) inward from the outer edge of the light control film LCF.

When the second adhesive layer OCA2 adhered to the light control film LCF is positioned to be outward more than the total distance, for example, spaced more than 1.4 millimeters (mm) outward from the outer edge of the light control film LCF, the second adhesive layer OCA2 is exposed, and thus foreign substances may be adhered to the second adhesive layer OCA2 or a stage during the process. In addition, when the size of the second adhesive layer OCA2 increases, a panel size also needs to increase, and thus the design of the product needs to be changed. Accordingly, it is very important to select a position in consideration of a position that is invisible from the outside and suitable for the panel size.

In the example implementation of the present specification, considering these points, the outer edges of the first adhesive layer OCA1, the second adhesive layer OCA2, and the light control film LCF and the chamfered shape of the first adhesive layer OCA1 are positioned within the range of the third distance C inward from the outer edge of the light control film LCF positioned on the outermost edge.

The third distance C spaced a predetermined distance outward from the outer end of the chamfered shape of the first adhesive layer OCA1 includes the first distance “a” spaced inward from the outer edge of the light control film LCF and the second distance “b” spaced inward from the outer edge of the second adhesive layer OCA2.

The third distance C may be equal to a value obtained by adding the first distance “a” and the second distance “b” or greater than the value obtained by adding the first distance a and the second distance b.

Accordingly, the measurement camera Cam can clearly distinguish and recognize the first adhesive layer OCA1, the second adhesive layer OCA2, and the light control film LCF within the focus of view FOV of the third distance C.

Meanwhile, in the display apparatus 100 according to the example implementation of the present specification, since only the first adhesive layer OCA1 is present when the light control film LCF is not present, the films do not overlap each other during the process, and thus the chamfered (C-cut) shape is not needed. As an example, the chamfered (C-cut) shape is needed when adhered to the light control film LCF, and thus may be applied to only the first adhesive layer OCA1 adhered to the light control film LCF

The display apparatus 100 according to the example implementation of the present specification may have the total distance of one of 1.07 millimeters (mm), 0.89 millimeters (mm), and 0.26 millimeters (mm) within the range of the third distance C from the outer edge of the outermost light control film LCF.

In the display apparatus 100 according to the example implementation of the present specification, the total distance of the third distance C for CTQ measurement may be set differently depending on a thickness, refractive index, a viewing angle (radian), and a focus of view of the first adhesive layer OCA1.

Meanwhile, the display apparatus 100 according to the present specification may include various additional elements for generating various signals or driving the pixels PX in the active area AA. Additional elements for driving the pixels may include an inverter circuit, a multiplexer, an electrostatic discharge circuit, etc. The display apparatus 100 according to the present specification may also include additional elements associated with functions other than pixel driving. For example, the display apparatus 100 according to the present specification may include additional elements for providing a touch detection function, a user authentication function (e.g., fingerprint recognition), a multi-level pressure detection function, a tactile feedback function, etc. The above additional elements may be positioned in the non-active area NA and/or an external circuit connected to a connection interface.

Various parts of the display apparatus 100 according to the present specification may be bent along a bending line. The bending line may extend horizontally, vertically, or diagonally. Accordingly, the display apparatus 100 according to the example implementation of the present specification may be bent in a combination of horizontal, vertical, and diagonal directions based on a required design.

One or more edges of the display apparatus 100 according to the present specification may be bent away from a central portion along the bending line. The bending line may be positioned close to the edge of the display apparatus 100, but may extend across the central portion or extend diagonally from one or more corners of the display apparatus 100.

Since one or more portions of the display apparatus 100 may be bent, the display apparatus 100 according to the present specification may be defined as having a substantially flat portion and a bent portion. A portion of the display apparatus 100 may be referred to as a substantially flat surface area. A portion of the display apparatus 100 may be bent at a predetermined angle, and such a portion may be referred to as a bending area or a curvature area. The curvature area includes a bent section that is actually bent with a predetermined bending radius.

The term “substantially flat” also includes a portion that is not perfectly flat. For example, a concave central portion and a convex central portion may also be described as substantially flat portions in some implementations. One or more bent portions are present next to the concave central portion or the convex central portion and are bent inward or outward at an angle with respect to a bending axis along the bending line. A bending radius of the curvature area is smaller than a bending radius of the flat surface area. As an example, the term “substantially flat portion” indicates a portion that has a smaller curvature than adjacent sections.

According to the position of the bending line, while a portion at one side of the bending line is positioned toward the center of the display apparatus 100, and a portion at the other side of the bending line is positioned toward the edge of the display apparatus 100. The portion that is positioned toward the center of the display apparatus 100 may be referred to as a central portion, and the portion that is positioned toward a corner of the display apparatus 100 may be referred to as a corner. In some cases, the central portion of the display apparatus 100 may be substantially flat, and the corner thereof may be a bent portion. The substantially flat portion may also be positioned on the corner. In addition, in some shapes of the display apparatus 100, the bent section may be disposed between two substantially flat portions.

When the non-active area NA is bent, the non-active area NA may be invisible or only minimally visible from the front surface of the display apparatus 100. A portion of the non-active area NA, which is visible from the front surface of the display apparatus 100, may be covered by a bezel, without being limited thereto. The bezel may be a stand-alone structure or may be formed of a housing or other suitable elements. A portion of the non-active area NA, which is visible from the front surface of the display apparatus 100, may be hidden below an opaque mask layer such as a black ink (e.g., a polymer filled with carbon black), without being limited thereto. Such an opaque mask layer may be provided on various layers (a touch sensor layer, a polarizing layer, a cover layer, etc.) included in the display apparatus 100.

As described above, according to the example implementation of the present specification, it is possible to achieve a display apparatus in which an outer shape of each film is accurately recognized during the manufacturing process of the display apparatus to secure alignment accuracy.

In addition, according to the example implementation of the present specification, it is possible to provide a display apparatus in which films are stacked so that an edge of each of the films above and below a display panel is offset inward from an outer edge by a predetermined distance, thereby reducing or preventing occurrence of poor boundary visibility of each film.

A display apparatus according to an example implementation of the present specification may be described as follows.

A display apparatus according to an example implementation of the present specification may include a display panel 20 including an active area in which a plurality of sub-pixels are disposed and a non-active area surrounding the active area, an optical control layer POL disposed on the display panel, a second adhesive layer OCA2 disposed on the optical control layer, a light control film LCF disposed on the second adhesive layer, a first adhesive layer OCA1 disposed on the light control film, and a cover member CG disposed on the first adhesive layer, in which an outer edge of the light control film among the light control film, the first adhesive layer, and the second adhesive layer may be positioned on an outermost edge, outer edges of the first adhesive layer and the second adhesive layer may be positioned inward more than the outer edge of the light control film, and the outer edge of the first adhesive layer may have a chamfered shape inward from each of four corner areas of the display panel.

According to some implementations of the present specification, the outer edge of the first adhesive layer and the outer edge of the second adhesive layer may overlap each other except for the chamfered shape.

According to some implementations of the present specification, the outer edges of the first adhesive layer and the second adhesive layer may be disposed to be spaced a first distance a inward from the outer edge of the light control film.

According to some implementations of the present specification, the chamfered shape for the outer edge of the first adhesive layer may be formed to be spaced a second distance b inward from the outer edge of the second adhesive layer.

According to some implementations of the present specification, the chamfered shape for the outer edge of the first adhesive layer may be formed as a plurality of chamfered shapes in each of the four corner areas of the display panel.

According to some implementations of the present specification, the chamfered shape may be formed as a plurality of chamfered shapes in each of the four corner areas of the display panel outside a spline area SLA of the display panel.

According to some implementations of the present specification, a black matrix may be disposed on the first adhesive layer, and the cover member may be disposed on the black matrix.

According to some implementations of the present specification, the black matrix may include a plurality of holes and may be formed by filling the plurality of holes with a black pigment.

According to some implementations of the present specification, the outer edge of each of the second adhesive layer, the light control film, and the first adhesive layer may be disposed at a position overlapping an end of the black matrix by a third distance C.

According to some implementations of the present specification, each of the chamfered shapes formed on outer edges of four sides of the first adhesive layer outside the spline area may be disposed at a position overlapping the end of the black matrix by the third distance C.

According to some implementations of the present specification, the third distance C may include chamfered shapes formed on the outer edges of the four sides outside each spline area of the first adhesive layer, and outer edges of four sides of each of the second adhesive layer and the light control film, which correspond one-to-one to the chamfered shapes.

According to some implementations of the present specification, the third distance C may include a first distance a spaced inward from the outer edge of the light control film LCF, and a second distance b spaced inward from the outer edge of the second adhesive layer OCA2.

According to some implementations of the present specification, the third distance C may have a value that is equal to a value obtained by adding the first distance a and the second distance b.

According to some implementations of the present specification, the third distance C may have a value that is greater than a value obtained by adding the first distance a and the second distance b.

According to some implementations of the present specification, the chamfered shapes formed on the outer edges of the four sides outside each spline area of the first adhesive layer, and the outer edges of the four sides of the second adhesive layer and the outer edges of the four sides of the light control film, which corresponding one-to-one to the chamfered shapes, may positioned below an end portion of the black matrix and may overlap the end portion of the black matrix.

Although the present specification has been described above with reference to the example drawings, the present specification is not limited by the example implementations and drawings disclosed in the present specification, and it is apparent that various modifications can be made by those skilled in the art within the scope of the technical spirit of the present specification. In addition, even when the operational effects according to the configuration of the present specification have not been explicitly described in the description of the example implementations of the present specification, it is apparent that the effects predictable by the corresponding configuration should also be recognized.

What is claimed is:

1. A display apparatus comprising:
a display panel;
a second adhesive layer disposed over the display panel;
a light control film disposed on the second adhesive layer; and
a first adhesive layer disposed on the light control film,
wherein an outer edge of the light control film is positioned as an outermost edge among the light control film, the first adhesive layer, and the second adhesive layer,
wherein an outer edge of the first adhesive layer and an outer edge of the second adhesive layer are positioned further inward than the outer edge of the light control film, and
wherein the outer edge of the first adhesive layer includes at least one chamfered portion that is recessed inward from the outer edge of the first adhesive layer.

2. The display apparatus of claim 1, wherein the outer edge of the first adhesive layer and the outer edge of the second adhesive layer overlap each other except in the at least one chamfered portion.

3. The display apparatus of claim 1, wherein the outer edge of the first adhesive layer, except for the at least one chamfered portion, and the outer edge of the second adhesive layer are disposed to be spaced a first distance inward from the outer edge of the light control film.

4. The display apparatus of claim 3, wherein the at least one chamfered portion of the outer edge of the first adhesive layer is spaced a second distance inward from the outer edge of the second adhesive layer.

5. The display apparatus of claim 1, wherein the at least one chamfered portion of the outer edge of the first adhesive layer comprises a plurality of chamfered portions at each of four corner areas of the display panel.

6. The display apparatus of claim 5, wherein the plurality of chamfered portions at each of the four corner areas of the display panel are disposed outside of a spline area of the display panel.

7. The display apparatus of claim 4, wherein a black matrix is disposed on the first adhesive layer.

8. The display apparatus of claim 7, wherein the black matrix includes a plurality of holes and is formed by filling the plurality of holes with a black pigment.

9. The display apparatus of claim 7, wherein the outer edge of the second adhesive layer, the outer edge of the light control film, and the outer edge of the first adhesive layer each overlaps the black matrix by at least a third distance.

10. The display apparatus of claim 9, wherein each of the at least one chamfered portion formed on outer edges of four sides of the first adhesive layer outside a spline area of the display panel is disposed at a position overlapping of the black matrix by the third distance.

11. The display apparatus of claim 10, wherein the third distance overlaps the at least one chamfered portion formed on the outer edges of the four sides of the first adhesive layer outside the spline area, and outer edges of four sides of each of the second adhesive layer and the light control film corresponding to the at least one chamfered portion.

12. The display apparatus of claim 9, wherein the third distance includes the first distance and the second distance.

13. The display apparatus of claim 12, wherein the third distance has a value that is equal to or greater than a value obtained by adding the first distance and the second distance.

14. The display apparatus of claim 7, wherein the at least one chamfered portion formed on the outer edges of four sides of the first adhesive layer outside a spline area, and the outer edges of four sides of each of the second adhesive layer and the light control film corresponding the at least one chamfered portion are positioned below the black matrix, and overlap the black matrix.

15. The display apparatus of claim 1, further comprising:
an optical control layer disposed on the display panel, the second adhesive layer being disposed on the optical control layer; and
a cover member disposed on the first adhesive layer.

16. The display apparatus of claim 1, wherein the at least one chamfered portion is disposed inward from the outer edge of the first adhesive layer, at each of four corner areas of the display panel.

17. The display apparatus of claim 1, wherein each of the at least one chamfered portion has a shape that is recessed in a trapezoidal shape inward from the outer edge of the first adhesive layer.

18. The display apparatus of claim 4, wherein the first distance is 0.25 mm or less, the second distance is 0.5 mm or less.

19. The display apparatus of claim 1, wherein the light control film includes a light transmissive film having a plurality of parallel grooves, and the grooves are filled with a light-absorbing material.

20. The display apparatus of claim 9, wherein a focus of view of a measurement camera for a critical to quality (CTQ) measurement is smaller than or equal to the third distance.

21. The display apparatus of claim 9, wherein the third distance is measured from the outer edge of the light control film to an inner edge of the black matrix.

22. The display apparatus of claim 9, wherein the at least one chamfered portion is formed at both sides of each of spline areas of the display panel, and
wherein at least two chamfered portions are formed at each of four sides of the first adhesive layer.
